(19) United States
(12) Patent Application Publication
(10) Pub. No.: US 2026/0288757 A1
(43) Pub. Date: Sep. 24, 2026

(54) SYSTEMS AND METHODS FOR RELIABLE DATABASE MIGRATION

(71) Applicant: WELLS FARGO BANK, N.A., San Francisco, CA (US)

(72) Inventors: Praveen Gondra, Fremont, CA (US); Pavan Dhanapuneni, Waxhaw, NC (US); Sebas Panikulam, Corcoran, MN (US)

(21) Appl. No.: 19/086,055

(22) Filed: Mar. 20, 2025

(51) Int. Cl. G06F 16/27

(52) U.S. Cl. CPC G06F 16/273

(57) ABSTRACT

Systems and methods for database migration are described. The systems and methods are described as encompassing a series of operations including receiving a message to a first database system where the first database system includes a production service coupled to a first database, and transmitting the message to the production service. The operations include storing the message in a message queue in a second database system including a test service coupled to the second database. The operations include transmitting the message to the test service, and, in response to the message, receiving a test response from the test service. The operations include logging the test response.

### FIELD OF INVENTION

The present disclosure generally relates to management of files in distributed computing environments, and more specifically, to systems and methods for reliable database migration.

### BACKGROUND

Database migration relates to the migration of data from a first database to a second database. Database migration can occur in various environments including within distributed computing (i.e., cloud computing) environments. Various changes in the architectures relative to a first environment storing the first database, and a second environment storing the second database can frustrate the migration of not only the data being migrated, but also the larger systems which are also migrated.

### SUMMARY

According to certain examples, a method is described. The method includes receiving a message to a first database system, the first database system including a production service coupled to a first database, transmitting the message to the production service, and storing the message in a message queue in a second database system. The second database system can include a test service coupled to the second database. The method further includes transmitting the message to the test service, receiving in response to the message, a test response from the test service, and logging the test response.

Another example relates to a system including one or more processors configured to perform operations. The operations include receiving a message to a first database system, the first database system including a production service coupled to a first database, transmitting the message to the production service, and storing the message in a message queue in a second database system. The second database system can include a test service coupled to the second database. The operations further include transmitting the message to the test service, receiving in response to the message, a test response from the test service, and logging the test response.

A further example relates to a non-transitory computer readable medium comprising instructions that, when executed by one or more processors, cause the one or more processors to perform operations. The operations include receiving a message to a first database system, the first database system including a production service coupled to a first database, transmitting the message to the production service, and storing the message in a message queue in a second database system. The second database system can include a test service coupled to the second database. The operations further include transmitting the message to the test service, receiving in response to the message, a test response from the test service, and logging the test response.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

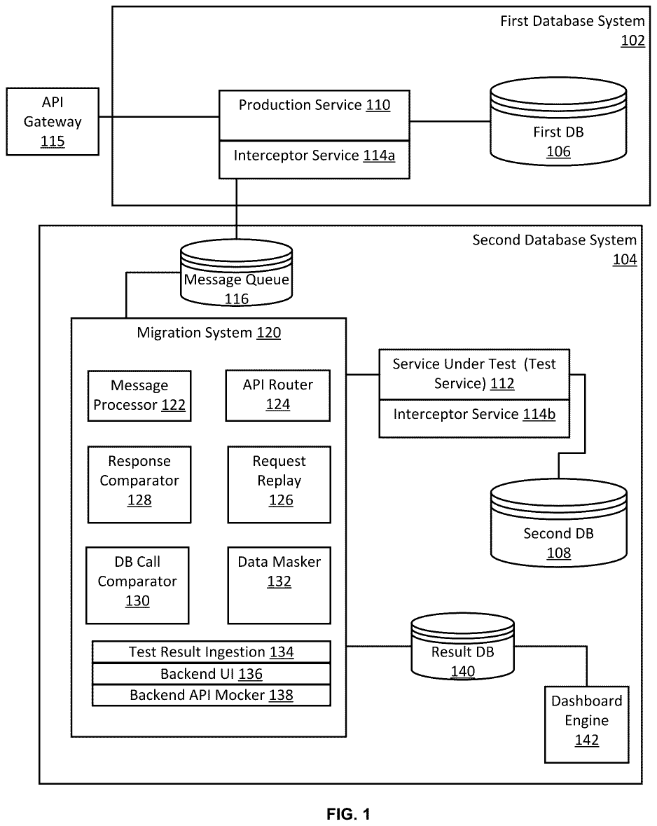

FIG. 1 shows a computing environment for reliable database migration, according to certain examples.

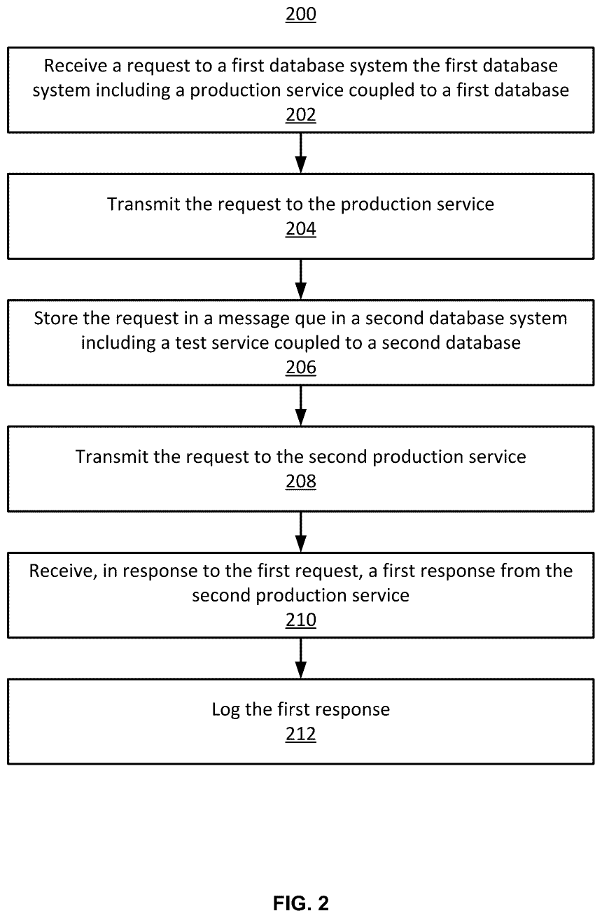

FIG. 2 shows an example process for reliable database migration, according to certain examples.

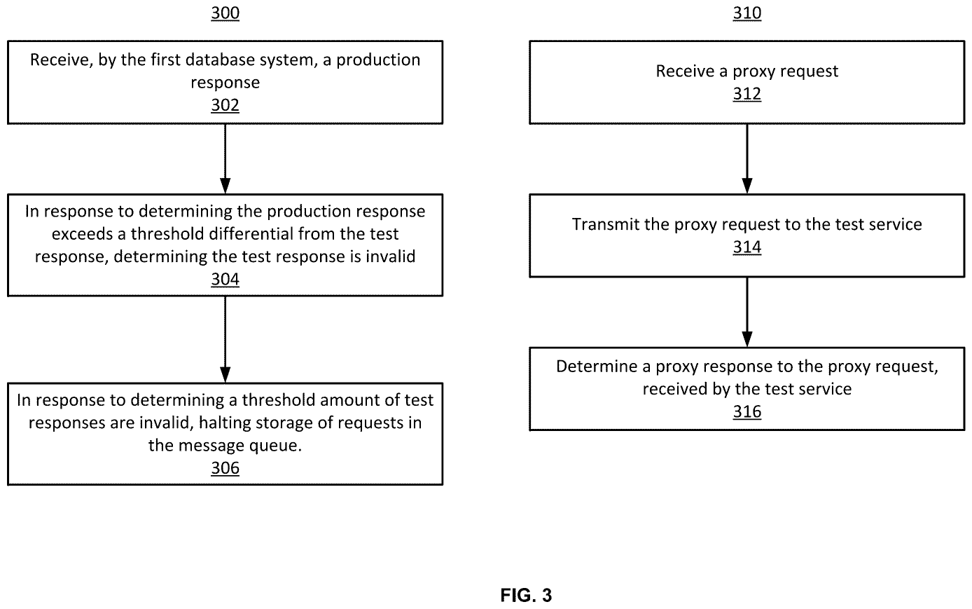

FIGS. 3A and 3B show example processes for comparing different responses during database migration operations, according to certain examples.

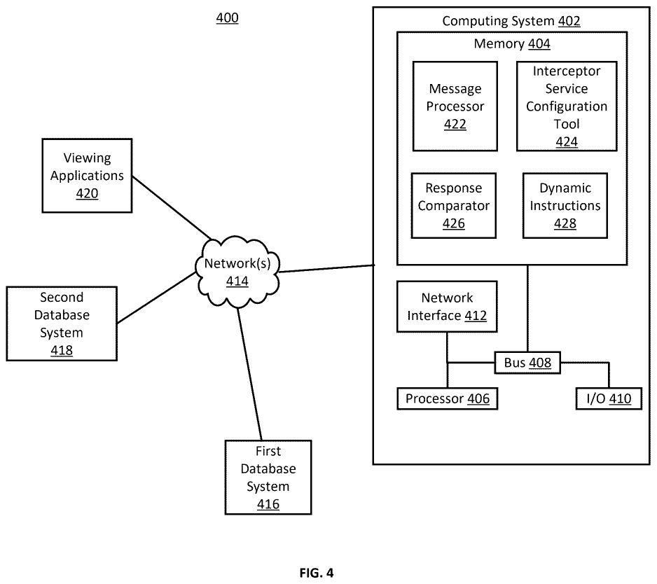

FIG. 4 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Database migrations within distributed computing environments are complex and difficult processes due to a host of complicating factors. Factors such as schema changes, data transformations, system dependencies and relationships, downtime and performance, client specific behavioral changes, backwards compatibility, access patterns, security changes, and the like each contribute to the complexity in performing database migrations. Moreover, systems developed iteratively may lack detailed functional behavior documents. Failure to account for iterative changes can lead to omissions in understanding the complete functionality of a database system, causing behavior to change and system downtimes. Achieving the pre-migration behavior with minimal system downtime and mitigating these issues requires meticulous planning, comprehensive testing, and robust pooling. Such planning can result in migrations processes taking longer than anticipated.

Test environments are not necessarily equal to production environments. Therefore, achieving production equivalent data within non-production environments is a complex and tedious task. Failure to mimic production grade test data can lead to missing bugs which may then surface in production. Unidentified issues in testing phases can lead to overall system downtimes, data corruptions, access issues, and other behavioral changes.

### Illustrative Example of Reliable Database Migration

Certain examples described herein address the limitations of previous techniques for migrating databases by providing the ability to test a first database system (i.e., a production system or “pre-migration system”) and a second database system (a test system or “post-migration system”) side by side with production real time data and compare the results in an automated way to provide feedback. The feedback can be used to fix identified issues resulting from discrepancies between the first database system and the second database system. Post-migration systems can then be instructed to come online once all issues are identified and resolved. The ability to test and debug the post-migration system while allowing the pre-migration system to operate normally can thus allow the efficient, reliable migration between database system.

The described migration system can include message/response interceptors to capture message (i.e., function call) and response (i.e., function output) data to push to a messaging system. The interceptors can also capture application programming interface (“API”) content to the messaging system. A client library including the interceptors can thus provide a “plug and play” environment for the system in production by choosing calls within the existing environment to provide for further testing. While reference is made generally to calls and API calls more specifically, it is to be appreciated that the described techniques can also be implemented on a batch level, where each batch intercepted by the interceptor service and implemented in the respective production service and test production service can include a collection of messages. The batches can be configured to be executed by the production service or test production service (e.g., via the message processor) in predefined time intervals.

The intercepted messages can be provided to a message queue which helps to de-couple the client library from the migration system. The message queue can provide message persistent storage until messages are proceed by the system in production. By de-coupling the client library from the new system in test, the new system in tests, or test system can operate asynchronously from the production system.

The migration system can contain multiple functions to complete the testing of the system in production such as message processing to read messages from the message queue, API routing to route messages between systems, collection and comparison of calls and responses between to the first database system and the second database system, data masking, and the like. Additional examples of functions and processes executed by the migration system are described in further detail according to the examples discussed throughout. Resulting databases and dashboards may also be provided to index and present data respectively, where the data is generated by functions within the migration system.

In an example workflow of the reliable database migration system, a production service (i.e., a client library) attached to the production system can intercept messages and responses via the interceptor service, and ingest the messages into the message queue and similarly transmit responses received by the production service to a migration system. The migration system, deployed in the same production environment, can read the message from the message queue and begin processing. The migration system's message processor and API router can parse the message to identify where in the second database system (e.g., which service within the test production service) to route the message. A request replay service will send a same request processed by the production system to the test production service within the second database system and collect the response from the test production service. The response comparator can compare the first database system response and the second database system response and generate tests results. Additionally, the database call comparator can compare the queries issued to the first database and the second database. The database comparator can also provide support in comparing entity specific database calls as well. Test results may then be sent to the result database after data masking completes. The data stored in the result database can then be made available to view from a user interface, and different test result dashboards can be built for analysis. Based on the test results, development teams can come into an understanding of the product quality and can make decisions as to whether to bring the second database system online in a production environment. The migration system may also provide a backend user interface (“backend UI”) to change processing configurations (i.e., how messages are processed according to the message processor) as well as to provide calls in the second database system environment without affecting the production system environment.

Certain aspects described herein overcome the above limitations of previous database migration systems. The improved system for testing and monitoring database system migrations are inextricably tied to improvements in computer technology, particularly that of distributed computing architecture and database management. As discussed above, previous migration systems have been unable to identify issues arising during the migration process due to the host of complexities in performing database migrations. Differences between test environments and production environments lead to missing bugs which later arise in production, and can lead to longer migration times in databases. The aspects of the described migration system are able to minimize downtime between the production environment going offline and the test environment coming online. Decoupling calls and responses within the production system for simultaneous operation in the test environment via interceptor services can allow for simultaneous testing of the test environment while the production system remains operational and unaffected.

Additionally, the described message queue, operating with a message processor within the migration system can perform operations to minimize invalid calls to the test production system, thereby reducing the number of processing cycles burdens on local processor systems. For example, the migration system can determine whether response are valid (i.e., whether the production system is able to return data indicating the production system is operational). In response to determining a threshold number of responses, the message processor can cause the message queue to halt storage of messages. Such automatic controls can limit the number of calls being stored in the message queue, conserving data storage within the message queue. The automatic controls can also conserve processing resources by preventing additional calls from being transmitted to the test environment.

### Example Computing Environment for Reliable Database Migration

FIG. 1 shows a computing environment for reliable database migration, according to certain examples. The example according to FIG. 1 are shown to illustrate the logical and physical implementation of the alternate record keeping and exception handling system according to certain embodiments. Other embodiments, however, are possible. For instance, certain components may be shown as distinct components to illustrate the progression of the data flow, while according to some embodiments, the physical implementation of such components may be implemented across the same device. It is to be appreciated that the example embodiments according to FIG. 1 are provided for illustrative purposes. Examples of implementations of the computing environment 100 capable of implementing the described embodiments of FIG. 1 are discussed further with respect to the computing system of FIG. 4.

The computing environment 100 shown in FIG. 1 can include a distributed computing environment wherein components may be communicatively coupled via one or more network, or may be connected physically. The computing environment 100 is shown including a first database system 102 (also referred to as the pre-migration system or production system) and a second database system 104 (also referred to as the post-migration system, or system under test). Each database system includes a respective production service 110 112, and interceptor services 114. The production services 110 112 allow for messages and calls, (request and responses) communicated via respective databases to be returned to a user via the API gateway 115. The production service 110 for example, can route calls to the first database 106 to maintain operability of the first database system 102. Thus, in a normal, pre-migration state, the first database system 102 operates by receiving calls via the API gateway 115, and directing the calls to the first database 106 through the production service 110. Similarly, in the system under test, the production service (referred to as the test service 112) when receiving calls via the migration system 120, can direct requests and receive responses via the second database 108.

Each of the production service 110 and the test service 112 is shown connected to an interceptor service 114. The interceptor services 114a 114b are able to capture requests and responses from the respective system. The interceptor service 114a operating within the first database system 102 can include a database calls interceptor, backend API call interceptor, and a request/response interceptor. The interceptor service 114b in the second database system 104 can include a database call interceptor. The configuration of the interceptor services communicatively coupled to each database system allows for requests and responses to be transmitted across the computing environment 100 without inhibiting the respective system 102 104. For instance, requests via the API gateway 115 to the production service 110 can be transmitted to the production service 110, which receives the request and accesses the first database 106, while the interceptor service 114a captures the request and transmits it to the message queue 116 for implementation in the second database system 104. The calls and responses within first database system 102 handled by the production service 110 will remain unaffected by the interceptor service 114a operations.

The first database 106 of the first database system 102 and the second database 108 of the second database system 104 refer to distinct databases, where distinctions may be based on file format, database structure, and the like. For instance, the first database 106 may comprise flat file format data (e.g., Java Script Open Notation “JSON”) while the second database 108 may comprise relational data formats (e.g., Structured Query Language “SQL”) or vice versa. The first database system 102 and the second database system 104 may also differ in other architecture, for instance, in variations in other functions and processes called by the respective production service 110 and test service 112.

Calls received, prior to entering either the first database system 102 or the second database system 104, are received by an API gateway 115. The API gateway 115 can receive calls including database queries, database insertions, database updates and the like. Additionally, the API gateway 115 can receive calls which indirectly call upon the database system through APIs connected to the respective production systems.

Requests received in the first database system 102 as intercepted by the interceptor service 114a may be logged in a message queue 116. In the example of FIG. 1, the message queue 116 is shown located within the second database system 104 environment. Thus, the message queue 116 can be decoupled from the first database system 102 where the production service 110 maintains nominal operations in communicating with the first database 106. The message queue 116 helps to de-couple the client library and is used as message persistent storage until processed by the second database system 104. The message queue further allows for the second database system 104 environment to operate asynchronously from the first database system 102 environment. The message queue 116 may have default settings and may also have configurable settings. For instance, in a default state, the message queue 116 may operate in first in first out order (“FIFO”). According to various queue configuration settings (e.g., received by the message processor 122), the message queue 116 may perform in other modes such as where messages are selectively processed within the message queue 116.

The message queue 116 is shown communicatively coupled to the migration system 120 within the second database system 104 environment. The migrations system 120 is shown including several modules (i.e., programmable, executable instructions), for executing a series of tasks to provide complete testing of the second database system 104. The migration system 120 is shown including a message processor 122. The message processor 122 includes instructions for consuming messages from the message queue 116 to begin processing of calls and requests as intercepted by the interceptor service 114. According to some examples, the message processor is configurable to provide for scalable processing of messages stored in the message queue 116 to provide increases in throughput.

Configuring the message processor 122 to consume messages from the message queue 116 can include operations based on message velocity. For instance, if an increased volume of calls over a given time are being received from the API gateway 115 and intercepted by the interceptor service 114a into the message queue 116, the message processor 122 can respond by filtering the number of calls consumed from the message queue 116. In response to a threshold velocity, the message processor, in some examples, reduces the message consumption rate from the message queue 116 to avoid overloading the test service 112 and second database system 104 more generally. Sampling a subset of the message queue 116 can include random sampling or distributed sampling of messages from the message queue 116. In the same or other examples, configurations of the message queue can react to a specific size threshold of the message queue 116 to responsively, selectively consume messages from the queue. For instance, once a certain number of messages are stored in the message queue 116, the message processor 122 can respond by switching to a filtration mode where only a subset of messages are transmitted to the test service 112.

The API router 124 is configured to identify the route of the second database system and API from the received message, and route the message accordingly. For instance, the test service 112 can include several functions which rely on accessing the second database 108. Each of the functions may have different configurations and thus different fault points. Different messages as intercepted by interceptor service 114a, stored in the message queue 116 may interact with various functions within the test service 112. The API router 124 can identify the specific function or process within the test service 112 to which the message should be routed. In such a manner, different functions and aspects of the second database system 104 can be targeted for testing. The API router 124 may also monitor the performance of the second database system 104 and automatically terminate processes based on the performance of the second database system 104. For instance, if a certain threshold of failures are detected in the second database system 104 (e.g., the test service 112 indicates access failures to the second database 108), the API router 124 may automatically respond by halting the interceptor service 114a from transmitting further messages into the message queue 116. Additionally or alternatively, the API router 124 can terminate execution of the test service 112. In such a way, the API router 124 can act as a circuit breaker to prevent degradations in system performance in both the first database system 102 and the second database system 104.

The migration system 120 includes a request replay service 126. The request replay service 126 includes instructions for causing messages, received by the message processor 122 and routed via the API router 124, to be executed within the second database system 104. The request replay service 126 can be executed according to REST APIs or any other call communication protocols. The request replay service 126 can also collect the responses received by the test service 112 which may be subsequently analyzed per the response comparator 128. The request replay service 126 service may also be responsible for handling variations in database calls between the first database system 102 and the second database system 104. For instance, calls within the first database system 102 may be premised on the first database 102 being in an XML format, while the second database 108 in the second database system 104 can include JSON formatted files. To facilitate calls originally intended for the first database 102, the message queue 116 can be configured to convert the calls into the format identified within the second database 108, or more generally, to be compliant with services within the test service 112.

The response comparator 128 includes programmable instructions for comparing the functionality of the production service 110 and the test service 112. For instance, the interceptor service 114a including a request/response interceptor can receive responses from the first database 106 and production service 110 and transmit the responses to the response comparator 128. The response comparator 128 also receives responses from the request replay service 126 from results of the message serviced in the second database system 104 environment. The response comparator 128 can include mapping configurations (e.g., field mapping comparisons) in examples where the first database 106 stores data in a first format and the second database 108 stores data in a second format, or in other instances where direct relationships may not be easily comparable between the first database system 102 and the second database system 104, such as where the production service 110 and the test service 112 provide different response types.

A database call comparator 130 may also be included for comparing entity (i.e., vendor) specific database calls issued between the first database system 102 and the second database system 104. The database call comparator 130 can compare the database queries executed by the production service 110 to the first database 106 and the database queries executed by the test service 112 to the second database 108. Because the databases can relate to different entities, the syntax executed by the respective services 110 112 may be different. The database call comparator 130 can account for such variations by mapping and configuring the syntax of each call to the corresponding entity or database to facilitate comparing messages processed in the first database system 102 and the second database system 104.

According to some examples, the migration system 120 can include a data masker 132. The data masker 132 can include instructions for masking sensitive data fields within calls, requests, and responses, prior to logging (e.g., within result database 140), The data masker 132 can thus ensure personally identifiable information (“PII”) and other sensitive assets within the messages and responses via the first database 106 or second database 108 are masked prior to output on various interfaces such as a backend UI 136 or a dashboard communicatively coupled to dashboard engine 142.

Test result ingestion service 134 can include instructions for ingestion of test results generated per the response comparator 128 into databases such as the result database 140. The backend UI 136 can provide an interface for users (i.e., backend developer teams) to interface with the second database system 104 and to monitor and configure the migration system 120. For instance, via the backend UI 136, the message processor 122 can be configured to specify the types of messages to be retrieved form the message queue 116 or the rate at which messages are to be retrieved from the message queue 116. The backend UI 136 can allow for manual configuration of each of the other components in the migration system 120, such as configuring the message processor 122, API router 124, request replay service 126 and the like. The backend UI 136 can similarly operate with a backend API mocker 138 to input additional proxy or “mock” calls into the second database system 104.

The backend API mocker 138 can allow for mock APIs and calls to be inserted into the second database system 104 environment and the test service 112, without having to execute the call via the production service 110. By inserting calls through the backend API mocker 138, users (e.g., backend developers) can implement specific tests within the second database system 104 and test service 112 to determine the functionality of the test service 112 and the second database 108. Such testing can allow for pinpointing and debugging specific errors within the second database system 104 downstream of the first database system 102 such that services within the first database system 102 remain uninterrupted. The backend API mocker 138, by obviating the need for calls to the first database system 102 to test the second database system 104, can reduce the number of calls and responses executed within the computing environment 100. By reducing the number of calls and responses executed, specifically in the first database system 102, backlogs and latencies arising in the first database system 102, ordinarily required according to other database migration techniques, may be reduced.

The test result ingestion service 134 can provide for test results generated by the request replay service 126 and response comparator 128 services to be ingested into a result database 140. The result database 140 can provide for persisting the test comparison results in various data formats, such as JSON format. Result database 140 can include search clusters, relational databases such as SQL, non-relational database (Not only SQL or “NoSQL”), or the like. The result database 140 can provide for indexing comparison result data and results of mock tests to facilitate searching and aggregation for reports. For instance, the result database 140 can be coupled to a dashboard engine 142 which facilitates output of comparison result data in graphical format on an associated user interface. The dashboard engine 142 can include interfaces such as PowerBL, Grafana, Splunk, and the like.

In an illustrative example of operations within the computing environment 100, a call routed through the production service 110 to the first database 106 will be intercepted by the interceptor service 114a for insertion into the second database system 104. While intercepted, the call will continue to execute via the production service 110, coupled to the first database 106 such that output responses from the production service 110 are routed back through the API gateway 115. Meanwhile, the intercepted message is transmitted to the message queue 116. Once retrieved from the message queue 116, the migration system 120 can execute the call within the test service 112 (e.g., via request replay service 126). If failures are detected, the results can be reported through the backend UI 136 or aggregated and displayed via a dashboard engine 142. Backend developers, alerted to failures or discrepancies between calls serviced by the production service 110 and the test service 112 can be keyed into specific faults within the second database system 104 environment. In response, the developers can interface through the backend UI 136 and backend API mocker 138 to instantiate specific calls within the second database system 104 to further debug operations within the second database system 104.

The operations of the reliable migration system, allowing users to compare performance between the first database system 102 and the second database system 104 can thus provide an efficient means for validating the performance of the second database system 104 as the system under test. Once satisfied, with the performance of the second database system, users can then interface with the migration system by providing approval input which may then reroute each message received at the first database system 102 to the second database system 104 and terminate transmission of each message to the production service 110.

### Example Process for Reliable Database Migration

FIG. 2 shows an example process for reliable database migration, according to certain examples. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the computing environment 100 of FIG. 1. In some aspects of the present disclosure, one or more operations shown in FIG. 2 may be omitted or performed in a different order. Similarly, additional operations not shown in FIG. 2 may be performed.

At block 202 the process 200 includes receiving a request to a first database system. The first database system 102 can include a production service 110 coupled to a first database 106. The first database system 102, also referred to as the production environment, can refer to a currently operational database system that is to be replaced with another database system, such as the second database system 104. The first database system 102 being currently operational means that calls routed through an API gateway 115 would be expected to be processed by the production service 110 communicating with the first database 106. As such, calls received via the API gateway 115 would generally be processed according to the production service 110 communicating with the first database 106, with the call processing minimally affected due to the architecture of the second database system 104

At block 204 the process 200 includes transmitting the request to the production service 110. In such a manner, the first database system 102 remains operational. The production service 110 can receive calls from the API gateway 115 and process the calls via operations with the first database system 102 (i.e., through retrieving data related to the call, request, or batch of requests, from the first database 106). The production service 110 can further transmit the response back to the API gateway 115 for additional processing or output to users.

At block 206 the process 200 includes storing the request in a message queue in a second database system. The second database system 104 can also include a test service 112 coupled to a second database 108. The request, as initially received in the first database system 102, can be intercepted by an interceptor service 114a communicatively coupled to the production service 110. The interceptor service 114a, in intercepting the request, can duplicate the request such that one version of the request proceeds to the production service 110 for processing in the first database system (as in block 204), while another version is stored in the message queue 116 per block 206.

In the examples of FIGS. 1 and 2, the message queue 116 is described as stored in the second database system 104, though it is to be appreciated that the message queue 116 may be stored in other locations. For instance, the message queue 116 may be stored in another location external the first database system 102, such that the message queue 116 decouples the requests stored in the message queue 116 from the first database system 102. Decoupling the message queue 116 from the first database system 102, such as by storing it in the second database system 104, can allow for the second database system 104 to perform operations and request processing asynchronously from the first database system 102.

At block 208 the process 200 includes transmitting the request to the test service 112. As described in FIG. 1, a migration system 120 including a request replay service 126, communicating with a message processor 122 and API router 124 instructions, can cause requests to be transmitted to the test service 112. The request replay service 126 can include programmable instructions for transmitting, or “replaying” the request that was processed within the first database system 102, within the second database system 104. The request replay service 126 can also collect responses from the test service 112 after the request is transmitted to the test service 112. The request replay service 126 can perform the request replays and request collections via communication with the message processor 122 and API router 124.

The message processor 122 can be configured to consume messages from the message queue 116 in various manners. In an example, a default mode can include processing each request from them message queue in a FIFO order. According to certain queue configuration settings, the message processor 122 can monitor the message queue 116 to determine triage operations for processing a subset of messages in the message queue 116. For instance, if a velocity of messages entering the message queue 116 from the interceptor service 114a exceeds first, second, or other threshold, the message processor 122 can respond by decreasing or increasing the amount of messages consumed by the migration system 120. Similarly, if the message queue 116 reaches first, second, and other thresholds in the amount of messages currently stored within the message queue 116, the message processor 122 may similarly increase or decrease sampling (i.e., increasing or decreasing the relative number of messages consumed from the queue). In some examples, specific request types may be identified as having preference in consumption. As a result, specified request types may be preferentially processed despite other message processor 122 constraints. Specific requests, such as database queries which are determined to have lower latency (e.g., based on similar performance of the query in the first database system 102), may be prioritized in the message queue 116 to reduce the size of the message queue 116 more quickly.

Transmitting the request to the test service 112, per block 208, can also include operations performed by the API router 124. The API router 124 can be configured to identify the route of the request within the second database system 104 so that the request is properly directed to the correct API within the test service 112. Because the test service 112 may have different structure than the first database system 102 (e.g., different APIs for executing similar processes), the API router 124 can be configured with mappings to translate an API call intended for the first database system 102, and update the routing to direct to a corresponding API within the second database system 104. The API router 124 may also automatically control the message queue 116 via monitoring operations. Additional operations of the API router 124 for controlling the message queue are described with respect to FIG. 3.

At block 210 the process 200 includes, receiving, in response to the first request, a test response from the test service 112. The request replay service 126, having received a response from the test service 112, can provide the received response to a response comparator 128. Responses received from the test service 112 can include outputs of function calls to the test service 112. Some outputs from the test service 112 can include null values, error flags, or other identifiers that the test service 112 failed to perform the request. In some examples, in response to detected failures, messages can automatically be transmitted to the migration system and output via an interface, such as the backend UI 136. If a threshold number or rate of failures are detected, operations of the interceptor service 114a or message queue can be halted to avoid message queue overflow. In examples where invalid responses are not detected, variations between the performance of the first database system 102 and the second database system 104 may still be provided. Thus, the test response, as received via the test service 112, can be logged per block 212.

At block 212 the process 200 includes logging the test response. Logging the test response can include logging the test response alone, or logging the test response in combination with a response from the request processed from the production service 110. For instance, the response comparator 128 can store comparisons between the test response and the first response from the production service 110. The logged comparison can be used for comparing the functionality of the first database system 102 (via the first, production response) and the second database system 104 (via the second, test response). Additionally, logging the test response (in conjunction with the first response) can include, via the data masker 132, masking sensitive data fields prior to logging the response. Logging the responses can include performing test result ingestion service 134 to upload the responses to a result database 140. Additional operations for comparing responses within the first database system 102 and the second database system 104 are described according to the examples of FIGS. 3A and 3B.

### Example Processes for Receiving and Comparing Requests

FIGS. 3A and 3B show example processes for comparing different responses during database migration operations, according to certain examples. For illustrative purposes, the processes 300 and 310 described with reference to implementations described above with respect to one or more examples described herein. Other implementations, however, are possible. In some aspects, the operations in FIGS. 3A and 3B may be implemented in program code that is executed by one or more computing devices such as the computing environment 100 of FIG. 1. In some aspects of the present disclosure, one or more operations shown in FIGS. 3A and 3B may be omitted or performed in a different order. Similarly, additional operations not shown in FIGS. 3A and 3B may be performed.

Process 300 includes operations for automatically controlling database migration operations, according to certain examples. At block 302 the process 300 includes receiving, by the first database system, a production response. The production response can be generated by processing the request, via the API gateway 115, at the first database system 102. The production response can thus reflect the operations of the first database system 102 in handling a given request. The response can be received by the interceptor service 114, communicatively coupled to the production service 110, and transmitted to the migration system 120 for evaluation by the response comparator 128.

At block 304 the process 300 includes, in response to determining the production response exceeds a threshold differential from the test response, determining the test response is invalid. The threshold differentials can be based on binary results from the test response. For instance, test responses including timeout errors, connection refusal errors, authentication errors (e.g., access denials, token expirations), query execution errors, and other data access errors can cause the response comparator to automatically flag the test response as invalid. In other examples, differentials can be based on comparing the syntax or semantic output differences between the production response and the test response. Examples can include data mapping and transformation errors (e.g., changes in decimal precision), schema compatibility errors (e.g., column repositioning identified in the second database), performance degradation in the time required to produce the test response compared to the production response, changes in configuration, and the like. According to some examples, each of these determined differences can be flagged and captured within the result database 140 for display via the dashboard engine 142.

In some examples, determining response invalidity can include identification of different severity levels due to message invalidity. For example, binary test result failures as discussed above, indicating the second database 108 or a portion of the test service 112 is inaccessible, can be identified as invalid responses which are more severe (e.g., hard-failures). Meanwhile, invalid responses determined due to syntactical or semantic responses between the first response and the second response, which otherwise do not result in specific failures, can be identified as invalid requests of lower severity (e.g., soft-errors). Therefore, the migration system 120 can, according to some examples, distinguish between hard-failures which indicate the second database system 104 is non-functional, and soft-errors which indicate the second database system 104 functions, but in a manner different from the first database system 102.

At block 306 the process 300 includes, in response to determining a threshold number of responses is invalid, halting storage of requests in the message queue. Determining a threshold number of responses is invalid can include determining an absolute number of responses of a particular request type are invalid, or number of all responses, regardless of request type are invalid. Similarly, the threshold can include a number of responses relative to a period of time are invalid. In such a manner, an increased velocity of errors detected by the migration system, resulting from configurations of the second database system 104, can cause the migration system to shut off additional request interceptions by the interceptor service 114.

In examples where soft-errors are distinguished from hard-errors, the process 300 at block 306 may have different tolerances based on the type of failure. For instance, a threshold number of hard-error invalid responses may be lower, leading to the message queue 116 and migration system 120 halting operations at a lower number of detected failures compared to the hard-errors.

Turning to FIG. 3B, additional aspects for comparing different responses-specifically proxy calls and proxy responses-during database migration operations are described. In some examples, the migration system 120 can include a backend UI 136 for allowing back-end users to bypass having to submit requests through the first database system 102, and instead submit requests (referred to as proxy requests) directly to the second database system 104. Process 310 includes operations for automatically controlling database migration operations, according to certain examples.

At block 312, the process 300 includes receiving a proxy request. The proxy request can be received via a backend UI 136 communicatively coupled to the second database system 104. As described in the example of FIG. 1, the backend UI 136 can allow users, such as developers to bypass the API gateway 115, production service 110, and optionally, the message queue 116. The proxy request can include a call or query to be processed by the test service., Because the backend UI 136 bypasses the first database system, 102, burdens and costs associated with otherwise having to execute the request in the first database system 102 can be avoided. For instance, the first database system, as the production environment, may be instantiated on a cloud network which may charge for requests or calls to the production service 110 on a pay-per-use basis. In technical implementation, reducing the number of calls necessary in order to directly test the second database system 104 can reduce the network traffic within the first database system 102. Reduced traffic via the unique configuration of the backend UI 136 thus provides a technical advantage in testing the second database system 104 compared to other database transmission techniques.

At block 314, the process 300 includes transmitting the proxy request to the test service 112. Transmitting the proxy request can be performed via the backend UI 136 communicating with the API router 124 and the message processor 122. For instance, the backend UI 136 may allow for users to prioritize the proxy request over messages currently stored in the message queue 116, such that the proxy request is transmitted to the test service 112 prior to a preexisting queue within the message queue. In other examples, the proxy request can be inserted into a specified section of the message queue 116. For instance, a user, operating via the backend UI 136 can create a batch of proxy requests for debugging and testing the second database system 104. The batch may be inserted into the message queue 116 at a specified position, or otherwise may be scheduled for testing at a specified time. Batches may be scheduled for example, during a low velocity period of incoming messages received at the message queue 116. Thus, each request, or a collection of requests forming a batch of requests, can be configured to execute automatically, superseding the preexisting message queue, or can be scheduled for transmission to the test service.

At block 316, the process 300 includes determining a proxy response to the proxy request, received by the test service. The test service can determine a proxy response to the proxy request in a manner similar to processing of the messages and requests as intercepted by the interceptor service 114a. Because the proxy request was generated via the backend UI 136 as opposed to via duplication at the interceptor service 114a, the proxy request may lack a corresponding response from the first database system 102 received at the production service 110.

To operate the response comparator 128, which is generally configured to compare paired responses from the first database system 102 and the second database system 104, the proxy request and proxy response may be automatically or manually paired with request types to compare against the first database system 102. Automatic pairing of the proxy response to a production response can include configuring the response comparator 128 to analyze metadata of the proxy response (e.g., file type, file size and the like) in order to determine a production response to compare the proxy response to. The proxy requests and responses may also be manually paired with request responses via user input into the backend UI (e.g., a user may identify the class of proxy request, and associated response, with a similar class type of a given production request and response). In other examples, the proxy response may not be paired with a corresponding production response. The proxy response may instead be output to the result database 140 and dashboard engine to provide direct input to any users debugging the second database system 104.

### Example Computing Environment for Database Migration Testing

Any suitable computing system or group of computing systems can be used for performing the operations described herein. For example, FIG. 4 shows a block diagram for a computing environment 400 capable of executing the described systems and methods, according to certain examples.

The depicted example of a computing system 402 includes one or more processors 406 communicatively coupled to one or more memory devices 404. The processor 406 executes computer-executable program code or accesses information stored in the memory device 404. Examples of processor 406 include a microprocessor, an application-specific integrated circuit (“ASIC”), a field-programmable gate array (“FPGA”), or other suitable processing device. The processor 406 can include any number of processing devices, including one.

The memory device 404 includes any suitable non-transitory computer readable medium for storing components of the migration system 120 such as the message processor 422, interceptor service configuration tool 424 (e.g., for transmitting messages controlling the operations of the interceptor services 114), response comparator 426, and other dynamic instructions 428 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 402 may also include a number of external or internal devices such as input or output devices. For example, the computing system 402 is shown with an input/output (“I/O”) interface 410 that can receive input from input devices or provide output to output devices. A bus 408 can also be included in the computing system 402. The bus 408 can communicatively couple one or more components of the computing system 402.

The computing system 402 executes program code that configures the processor 406 to perform one or more of the operations described above with respect to FIGS. 1-3. The program code includes operations related to, for example, causing an interceptor service to capture requests within a production service, transmit the captured requests to a test service, and compare the results of the responses of each production system. The program code may be resident in the memory device 404 or any suitable non-transitory computer-readable medium and may be executed by the processor 406 or any other suitable processor. In some embodiments, the program code described above, including the message processor 422, interceptor service configuration tool 424, response comparator 426, and other dynamic instructions 428 or received or determined values or data objects are stored in the memory device 404, as depicted in FIG. 4. In additional or alternative embodiments, one or more of the message processor 422, interceptor service configuration tool 424, response comparator 426, and other dynamic instructions 428 or received or determined values or data objects described above are stored in one or more memory devices accessible via a data network, such as a memory device accessible via a cloud service.

The computing system 402 depicted in FIG. 4 also includes at least one network interface. The network interface 412 includes any device or group of devices suitable for establishing a wired or wireless data connection to one or more data networks 414 such as viewing applications 420 including user interfaces. Non-limiting examples of the network interface 412 include an Ethernet network adapter, a modem, and/or the like. The computing system 402 is able to communicate with each of the of first database system 416 and the second database system 418 to perform the operations described herein.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

1. A method comprising, during a database migration from a first database system to a second database system:
receiving, at an interceptor service, a message directed to the first database system, the first database system including a production service coupled to a first database;
duplicating, via the interceptor service, the message into a first message and a second message;
transmitting the first message to the production service;
transmitting a response generated by the first database system;
transmitting the second message to a message queue in the second database system including a test service coupled to a second database;
storing the second message in the message queue transmitting the second message to the test service;
receiving, in response to the second message, a test response from the test service; and
logging the test response.

2. The method of claim 1, wherein the first database comprises data of a first file type, and the second database comprises data of a second file type different from the first file type.

3. The method of claim 1, further comprising determining whether the test response is valid.

4. The method of claim 3, wherein determining whether the test response is valid includes:
receiving, by the first database system, a production response; and
in response to determining the production response exceeds a threshold differential from the test response, determining the test response is invalid.

5. The method of claim 3, further comprising:
in response to determining a threshold number of responses are invalid, halting storage of messages in the message queue.

6. The method of claim 1, wherein the message queue includes a plurality of messages, and the message is retrieved from the message queue based on queue configuration settings.

7. The method of claim 6, wherein the queue configuration settings include:
comparing a velocity of messages stored in the message queue to a threshold velocity; and
responsive to determining the velocity exceeds the threshold velocity, returning a subset of the plurality of the message.

8. The method of claim 1, further comprising:
receiving a proxy request;
transmitting the proxy request to the test service; and
determining a proxy response to the proxy request received by the test service.

9. The method of claim 1, further comprising, prior to logging the test response, masking the test response.

10. The method of claim 1, further comprising, in response to receiving approval input:
rerouting each message received at the first database system to the second database system; and
terminating transmission of each message to the production service.

11. A system comprising:
one or more processors configured to, during a database migration from a first database system to a second database system:
receive, at an interceptor service, a message directed to the first database system, the first database system including a production service coupled to a first database;
duplicate, via the interceptor service, the message into a first message and a second message;
transmit first the message to the production service;
transmit a response generated by the first database system;
transmit the second message to a message queue in the second database system including a test service coupled to a second database;
store the second message in the message queue in the second database system including a test service coupled to a second database;
transmit the second message to the test service;
receive, in response to the second message, a test response from the test service; and
log the test response.

12. The system of claim 11, wherein the first database comprises data of a first file type, and the second database comprises data of a second file type different from the first file type.

13. The system of claim 11, wherein the one or more processors are further configured to determine whether the test response is valid.

14. The system of claim 13, wherein determining whether the test response is valid includes:
receiving, by the first database system, a production response; and
in response to determining the production response exceeds a threshold differential from the test response, determining the test response is invalid.

15. The system of claim 13, wherein the one or more processors are further configured to:
in response to determining a threshold number of responses are invalid, halt storage of messages in the message queue.

16. The system of claim 11, wherein the message queue includes a plurality of messages, and the message is retrieved from the message queue based on queue configuration settings.

17. The system of claim 16, wherein the queue configuration settings include:
comparing a velocity of messages stored in the message queue to a threshold velocity; and
responsive to determining the velocity exceeds the threshold velocity, returning a subset of the plurality of the messages.

18. The system of claim 11, wherein the one or more processors are further configured to:
receive a proxy request;
transmit the proxy request to the test service; and
determine a proxy response to the proxy request received by the test service.

19. The system of claim 11, wherein the one or more processors are further configured to: prior to logging the test response, masking the test response.

20. A non-transitory computer readable medium comprising instructions that, when executed by one or more processors, cause the one or more processors to, during a database migration from a first database system to a second database system:
receive, at an interceptor service, a message directed to the first database system, the first database system including a production service coupled to a first database;
duplicate, via the interceptor service, the message into a first message and a second message;
transmit the first message to the production service;
transmit a response generated by the first database system;
transmit the second message to a message queue in the second database system including a test service coupled to a second database;
store the second message in the message queue in the second database system including a test service coupled to a second database;
transmit the second message to the test service;
receive, in response to the second message, a test response from the test service; and
log the test response.
